(19) United States
(12) Patent Application Publication
(10) Pub. No.: US 2018/0352800 A1
(43) Pub. Date: Dec. 13, 2018

(54) FOGGING / MISTING APPARATUS WITH LOW CFM BLOWER AND MIXING CHAMBER FOR ULTRA-LOW VOLUME ATOMIZED FOG

(71) Applicant: BOSTON FOG, LLC, Waltham, MA (US)

(72) Inventors: Barry FRANKS, Derry, NH (US); John VALLERAND, Burlington, MA (US); Paul QUARANTO, Waltham, MA (US)

(21) Appl. No.: 15/768,801

(22) PCT Filed: Oct. 14, 2016
(86) PCT No.: PCT/US2016/057199

§ 371 Date: Apr. 16, 2018

Related U.S. Application Data
(63) Continuation of application No. 15/234,315, filed on Aug. 11, 2016.
(60) Provisional application No. 62/242,523, filed on Oct. 16, 2015.

(51) Int. Cl. A01M 13/00; A01M 1/20; B01F 3/04; B01F 15/02

(52) U.S. Cl. CPC A01M 13/00; A01M 1/2038; A01M 1/2033; B01F 15/0254; B01F 3/04056; A01M 1/2022

(57) ABSTRACT

A fogger apparatus and related methods are disclosed. The fogger apparatus includes a portable fogger body. A DC blower motor is positioned on the portable fogger body and is powered with a battery, wherein the DC blower motor produces air flow through at least one passageway within the portable fogger body. A quantity of fogging liquid is housed within a container positioned on the portable fogger body, wherein at least a portion of the quantity of fogging liquid is dispensable from the container. An activation switch controls at least one of activation of the DC blower motor and dispensing of the portion of the quantity of fogging liquid. A mixing chamber receives the air flow and the dispensed portion of the quantity of fogging liquid. The dispensed portion of the quantity of fogging liquid is expelled through a nozzle as a particulate having adjustable droplets sizes.

### CROSS REFERENCE TO RELATED APPLICATION

This application is a continuation-in-part, and claims the benefit, of U.S. Provisional Application Ser. No. 62/242,523 filed Oct. 16, 2015 and U.S. patent application Ser. No. 15/234,315 filed Aug. 11, 2016, which is a continuation application of U.S. patent application Ser. No. 14/099,319 filed Dec. 6, 2013, now U.S. Pat. No. 9,414,580, which claims priority to U.S. Provisional Application Ser. No. 61/864,164 filed Aug. 9, 2013, the entire disclosures of which are incorporated herein by reference.

### FIELD OF THE DISCLOSURE

The present disclosure is generally related to mixing chambers and more particularly is related to a fogging apparatus having a low CFM DC-powered blower motor and a mixing chamber for ultra-low volume atomized fog.

### BACKGROUND OF THE DISCLOSURE

A fogger is a device that creates a fog or mist or small particulate size typically converted from a fluid, such as an insecticide for killing insects and other biological material. Foggers are often used by consumers and professional pest control services, but may also be used for other purposes, such as sanitization. Within the industry, there are two main choices for fogging tools: (1) a thermal fogger; and (2) an electric-corded fogger. Both of these foggers have significant drawbacks.

The thermal fogger uses heat to create a fog with small particle sizes—often too small—and do not actively stick to the insect target, but deter them. The insect will fly away upon application of the fog and return when the fog clears out. Additionally, the thermal fog clouds produced can remain suspended within the air and travel to areas which were not intended to receive treatment, such as neighboring yards, water areas and other non-targeted areas. Beyond producing a small particle size, thermal foggers present many problems with their use. They require a liquid or gas fuel source, commonly propane, which can be dangerous in many settings, such as around open flames. Thermal foggers also create significant amounts of heat which can cause burning injuries to the operator. Additionally, thermal foggers are cumbersome and difficult to use in confined areas, such as attics.

Electric-corded foggers do not use heat and produce a cold fog, which is comprised of droplet sizes averaging fewer than 25 microns. This size is the optimal size for killing the targeted insect or microorganisms. However, electric-corded foggers are limited to only AC power and therefore, they are limited to the being used only where an AC power cord can reach. Conventional electric-corded AC foggers operate by siphoning from a liquid tank to a small orifice jet to create the atomized fog. They use high cubic foot per minute (CFM) volume generation, commonly above 120 CFM. They also have high air speeds generated by the AC blow motor to produce high pressure air which is channeled through a vortex or turbine. As the high pressured air passes the liquid jet, the air siphons the liquid from the tank and creates atomized particles. These conditions cannot be achieved with cordless foggers. Using battery-powered DC motors with these conventional electric-corded foggers cannot produce a high enough CFM or air flow to achieve the desired particulate size of at or under 25 microns.

Thus, a heretofore unaddressed need exists in the industry to address the aforementioned deficiencies and inadequacies.

### SUMMARY OF THE DISCLOSURE

Embodiments of the present disclosure provide a fogger apparatus and related methods. Briefly described, in architecture, one embodiment of the apparatus, among others, can be implemented as follows. A fogger apparatus has a portable fogger body. A DC blower motor is positioned on the portable fogger body and powered with at least one battery, wherein the DC blower motor produces an air flow through at least one passageway within the portable fogger body. A quantity of fogging liquid is housed within a container fluidly connected to the portable fogger body, wherein at least a portion of the quantity of fogging liquid is dispensable from the container. An activation switch controls at least one of activation of the DC blower motor and dispensing of the portion of the quantity of fogging liquid. A mixing chamber receives the air flow and the dispensed portion of the quantity of fogging liquid, wherein the dispensed portion of the quantity of fogging liquid is expelled through a nozzle as a particulate having a size less than 25 microns.

The present disclosure can also be viewed as providing methods of generating a low-CFM fog with a portable, battery-powered fogging apparatus. In this regard, one embodiment of such a method, among others, can be broadly summarized by the following steps: initiating an airflow through at least one passageway of the portable, battery-powered fogging apparatus with a DC powered blower motor receiving power from at least one battery; expelling a quantity of fogging liquid from a non-pressurized container; expelling the quantity of fogging liquid through a nozzle positioned proximate to an opening within a mixing chamber, wherein the quantity of fogging liquid exits the nozzle at an atomized micron particulate size between 5 and 60 microns; and atomizing the expelled quantity of fogging liquid with the airflow to produce a fog at 190 CFM and at a velocity of less than 190 MPH.

The present disclosure can also be viewed as providing a fogger apparatus. Briefly described, in architecture, one embodiment of the apparatus, among others, can be implemented as follows. The fogger apparatus has a portable fogger body. A DC blower motor is positioned on the portable fogger body and powered with at least one battery, wherein the DC blower motor produces an air flow through at least one passageway within the portable fogger body. A quantity of fogging liquid is housed within a container fluidly connected to the portable fogger body, wherein at least a portion of the quantity of fogging liquid is dispensable from the container using gravity. A first activation switch controls activation of the DC blower motor. A second activation switch controls a pump positioned inline with fluid tubes connected to the container, wherein the second activation switch controls dispensing of a portion of the quantity of fogging liquid from the container. A mixing chamber receives the air flow and the dispensed portion of the quantity of fogging liquid, wherein the dispensed portion of the quantity of fogging liquid is expelled through a nozzle as a particulate having a size less than 25 microns.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a side view illustration of a fogger apparatus, in accordance with a first exemplary embodiment of the present disclosure.

FIG. 2 is a front view illustration of a fogger apparatus of FIG. 1, in accordance with a first exemplary embodiment of the present disclosure.

FIG. 3 is a cross-sectional view illustration of a mixing chamber of the fogger apparatus of FIG. 2 along the line A-A, in accordance with a first exemplary embodiment of the present disclosure.

FIG. 4 is a cross-sectional top view illustration of a nozzle of the fogger apparatus of FIG. 1, in accordance with a first exemplary embodiment of the present disclosure.

FIG. 5 is a front view illustration of the nozzle of the fogger apparatus of FIG. 1, in accordance with a first exemplary embodiment of the present disclosure.

FIG. 6 is a side view illustration of a fogger apparatus, in accordance with a second exemplary embodiment of the present disclosure.

FIGS. 7-8 are side view illustrations of a fogger apparatus, in accordance with a third exemplary embodiment of the present disclosure.

FIG. 9 is a side view illustration of a fogger apparatus, in accordance with a fourth exemplary embodiment of the present disclosure.

FIG. 10 is a flowchart illustrating a method of generating a low-CFM fog with a portable, battery-powered fogging apparatus in accordance with a fifth exemplary embodiment of the disclosure.

### DETAILED DESCRIPTION

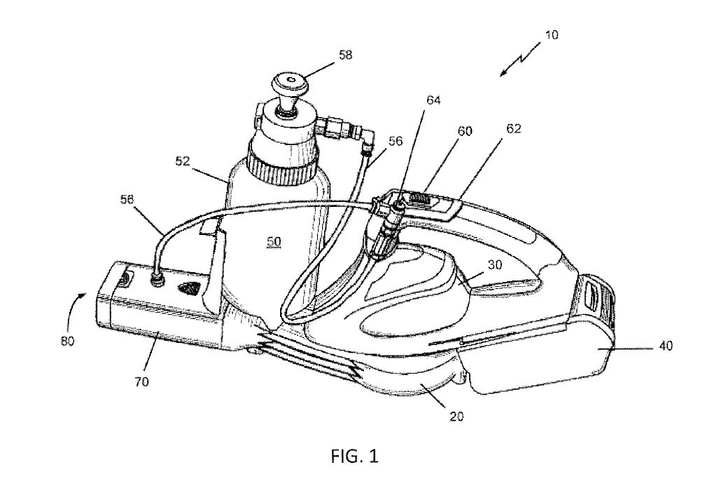

FIG. 1 is a side view illustration of a fogger apparatus 10, in accordance with a first exemplary embodiment of the present disclosure. The fogger apparatus 10, which may be referred to herein as ‘apparatus 10’ includes a portable fogger body 20. A DC blower motor 30 is positioned on the portable fogger body 20 and is powered with at least one battery 40, wherein the DC blower motor 30 produces an air flow through at least one passageway within the portable fogger body 20. A quantity of fogging liquid 50 is housed within a container 52 positioned on the portable fogger body 20, wherein at least a portion of the quantity of fogging liquid 50 is dispensable from the container 52. An activation switch 60 controls at least one of activation of the DC blower motor 30 and dispensing of the portion of the quantity of fogging liquid 50. A mixing chamber 70 receives the air flow and the dispensed portion of the quantity of fogging liquid 50, wherein the dispensed portion of the quantity of fogging liquid 50 is expelled through a nozzle 80 as a particulate having a size less than 25 microns.

The apparatus 10 is a fogging unit which does not rely on an electric power cord or gas/propane to operate. Rather, the apparatus utilizes a battery 40 to power a DC blower motor 30 to create a fog and/or mist to combat insects and other biological material. As discussed in the Background, conventional foggers use either heat or a corded-electric AC motor to create fog. The apparatus 10 is portable in that it is capable of being transported relatively easily without connection to a power source, such as an electric cord. The apparatus 10 may be used within any industry or market, including those directed to pest control, bio control, microbial, medical, or other industries.

The portable fogger body 20 may be a structure that houses the various components of the apparatus 10. The portable fogger body 20 may be constructed from plastics, metals, or another material. When coupled with the DC blower motor 30, positioned on the portable fogger body 20, and powered with one or more batteries 40, the apparatus 10 is fully portable and can be moved into a variety of locations and settings, irrespective of corded-power accessibility. As is shown in FIG. 1, the DC blower motor 30 may be integrally formed on the body 20 and the battery 40 may be removably from the body 20, thereby allowing it to be recharged when the apparatus 10 is not in used.

The DC blower motor 30 operates with only direct-current (DC) power, and does not use alternating-current (AC) power. The battery 40 provides the DC power source to the DC blower motor 30, thereby allowing the DC blower motor 30 to produce air flow. The battery 40 may include a 6 volt to 90 volt DC battery. The air flow may traverse through one or more passageways within the portable fogger body 20, such as a passageway that connects the DC blower motor 30 with the mixing chamber 70. In FIG. 1, the passageway is internal of the portable fogger body 20 and generally defined by the various structures that comprise the portable fogger body 20.

A quantity of fogging liquid 50 is housed within a container 52 positioned on the portable fogger body 20. The fogging liquid 50 may be any type of liquid used with fogging, such as hydrogen peroxide, or other commonly-used chemicals. The container 52 may be positioned on the portable fogger body 20 such that it is retained to the body 20 with a retaining mechanism 54. In other embodiments, it is possible for the container 52 to be positioned remote from the portable fogger body 20, such as on the back of the user of the apparatus 10. All positions of the container 52 relative to the portable fogger body 20 are considered within the scope of the present disclosure. The container 52 may be connected to the portable fogger body 20 or other components with a plurality of tubes 56 which can carrying the dispensed portion of the fogging liquid 50. As is shown in FIG. 1, the tubes 56 may connect the container 52 with the activation switch 60 and the activation switch 60 to the mixing chamber 70. Any number of tubes 56 and/or other fogging liquid transportation structures may be used with the apparatus 10. As will be discussed further herein, the fogging liquid 50 may be pressurized.

An activation switch 60 controls activation of the DC blower motor 30 and/or dispensing of the portion of the quantity of fogging liquid 50. The activation switch 60 may include one or more switches, operated concurrently or independently. For example, as is shown in FIG. 1, a first switch 62 may control activation of the DC blower motor 30 while a second switch 64, such as a shut off valve, controls flow of the fogging liquid 50. The two switches 62, 64 may be combined as one. When in use, the operator of the apparatus 10 may conveniently activate the first or second switch 62, 64 to provide proper application of the fog.

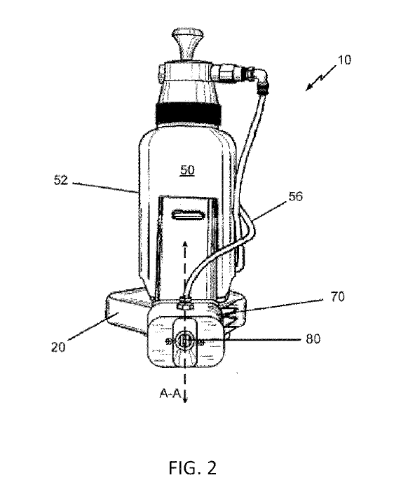

A mixing chamber 70 may be positioned at an end of the portable fogger body 20. The mixing chamber 70, described further in detail relative to FIGS. 2-5, receives the air flow from the DC blower motor 30 and the dispensed portion of the quantity of fogging liquid 50. A nozzle 80 within the mixing chamber 70 may combine the air flow and the dispensed portion of the fogging liquid 50 to provide optimal fog, i.e., fog that has the optimal particulate size, optimal throw distance, and optimal spray angle. The fog is created from the combination of the air flow past the nozzle 80 and the dispensed portion of the quantity of fogging liquid 50 being expelled through the nozzle 80. While optimal particulate size may vary, in accordance with this disclosure, optimal particulate size of the fog created by the apparatus 10 is adjustable via selected to nozzles to offer ULV micron(s) droplets under 50 Micron(s) and Mist Size micron(s) droplets averaging over 50 micron(s) and preferably between 80 micron(s)-140 micron(s).

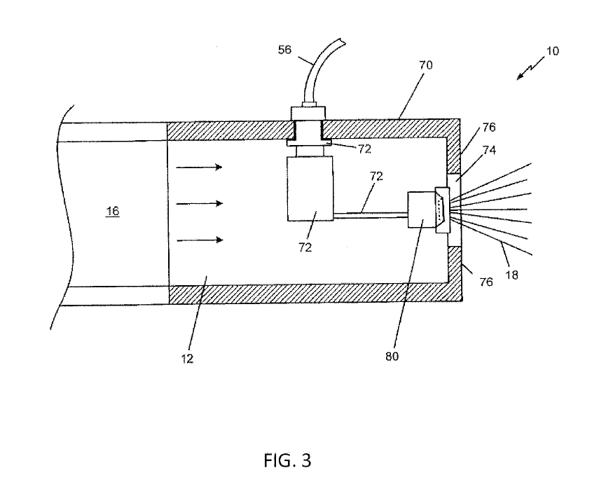

FIG. 2 is a front view illustration of a fogger apparatus 10 of FIG. 1, in accordance with a first exemplary embodiment of the present disclosure. As can be seen in FIG. 2, the tube 56 carrying the dispensed portion of the fogging liquid 50 may be connected to the mixing chamber 70. The tube 56 may traverse through the mixing chamber 70 and connected to the nozzle 80, which is located fully or substantially fully within the mixing chamber 70. The air flow created by the DC blower motor 30 (FIG. 1), may traverse through the lower portion of the portable fogger body 20 and into the mixing chamber 70. The mixing chamber 70 and the nozzle 80 are discussed in detail relative to FIGS. 3-5.

FIG. 3 is a cross-sectional view illustration of a mixing chamber 70 of the fogger apparatus 10 of FIG. 2 along the line A-A, in accordance with a first exemplary embodiment of the present disclosure. As is shown in FIG. 3, the air flow, which is generally identified by arrows 12, may enter one side of the mixing chamber 70. The air flow 12 passes by the nozzle 80 and exits the mixing chamber 70 via the opening 74 formed within a portion of the front wall 76, such as a middle portion of the front wall 76. The front wall 76 may be positioned substantially perpendicular to the sidewalls of the mixing chamber 70, forming corners between the front wall and the side walls. Concurrently, the tube 56 provides the dispensed portion of the fogging liquid 50 (FIGS. 1-2) into the mixing chamber 70 via a variety of connectors 72, which facilitate transportation of the dispensed portion of the fogging liquid 50 along with the tubes 56. The nozzle 80, which may be positioned substantially in a plane formed between the corners formed by the front wall and the side walls, may receive the dispensed portion of the fogging liquid 50 and expel it proximate to the opening 74. As soon as the dispensed portion of the fogging liquid 50 is expelled, it is mixed with the air flow 12 to create fog.

The nozzle 80 may be positioned a specific distance away from the opening 74 to provide optimal spray of the dispensed portion of the fogging liquid 50 without subjecting the nozzle 80 to the hazardous of operating the apparatus 10, such as inadvertently contacting the nozzle 80 and damaging it. For example, the nozzle 80 may be positioned one inch or less from the opening 74. The position of the nozzle 80 relative to the opening 74, along with the angle of the nozzle 80 and the pressure or suction created by the mixing chamber upon the dispensed portion of the fogging liquid 50 may provide for optimal throw distances of the fog. For example, the apparatus 10 may achieve initial throw distances of 25 feet or more and subsequent distance due to the continual ejection of the fog.

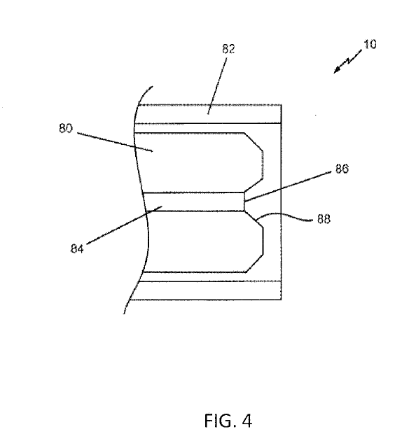

FIG. 4 is a cross-sectional top view illustration of a nozzle 80 of the fogger apparatus 10 of FIG. 1, in accordance with a first exemplary embodiment of the present disclosure. The nozzle 80 may include an outer housing 82 which is surrounding the nozzle 80. The nozzle 80 includes a fluid path 84 terminating in an orifice 86, positioned at the end of the nozzle 80. Proximate to the orifice 86, the nozzle 80 may include angled sides 88 which direct the spray of the dispensed portion of the fogging liquid 50 that exits the orifice 86. These structures of the nozzle 80 may create a breakdown of the dispensed portion of the fogging liquid 50 forced through the nozzle 80. For example, the angled sides 88 may control the breakdown shape of the spray, whether it is a fan, a flat, a cone, or another shape. While these are good nozzle patterns which can break down and scatter the dispensed portion of the fogging liquid 50, others may be used too. The nozzle 80 may require a 10°-85° (ten to eighty-five degree) opening and an orifice size less than 0.05 (five thousandths) of an inch. A materially larger orifice size may result in too large of a spray of the dispensed portion of the fogging liquid 50 to atomize properly. For lower Micron(s) droplets the smaller the orifice 0.05 (five thousandths)-0.30 size and lower pressure of liquid pulled via the mixing chamber caused by the venturi will result in smallest micron(s) droplets

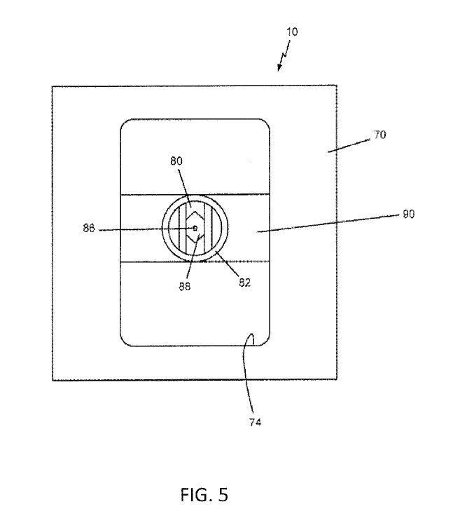

FIG. 5 is a front view illustration of the nozzle 80 of the fogger apparatus 10 of FIG. 1, in accordance with a first exemplary embodiment of the present disclosure. As can be seen in FIG. 5, the nozzle 80 may be supported within the mixing chamber 70 with a member 90 that is connected to the mixing chamber 70 and the nozzle 80. The member 90 may contact or surround any portion of the nozzle 80. The member 90 may also connect to the mixing chamber 70 via any means, such as threaded fasteners, adhesives, or others. Additionally, as is shown in FIG. 5, the shape of the spray from the nozzle 80 may be orientated to substantially match a shape of the opening 74 of the mixing chamber 70. For example, in FIG. 5, the spray may be shaped to match the generally elongated height of the opening 74. Depending on the desired use of the apparatus 10, the shape and/or direction of the nozzle 80 and opening 74 may be changed.

Relative to FIGS. 1-5, the fogging liquid 50 may be pressurized to provide proper dispensing of the fogging liquid 50 to the mixing chamber 70. While a variety of pressures of the fogging liquid 50 may be acceptable, it may be beneficial to have a fogging liquid 50 that is less than 50 PSI. Pressurization of the fogging liquid 50 may be achieved via manual means, such as a pressurizing valve on the top of the container 52, or via automatic means.

The pressurized fogging liquid 50 when ejected from the apparatus 10 within the nozzle 80 is atomized because the particles are small and manageable, allowing for proper mixing of the dispersed micron droplets when exposed to the passing air from the low CFM DC blower motor 30. This combination results in atomized droplets of the fogging liquid 50 with particle micron sizes suited for either ULV or Mist treatments. A large, fifty thousandths of an inch orifice 86 or greater size may create very large micron(s) sizes which may be suitable for wet application of bio threats, but for flying insects the application of an eleven-thousandths (0.011 inch) sized orifice 86 to a twenty-eight thousandths (0.028 inch) sized orifice 86 is ideal for ULV.

When manual means are used to pressurize the fogging liquid 50, a pressurized bottle or tank may be used as the container 52. When manually activated by priming, pumping, or trigger action, the pumping mechanism will disperse fogging liquid 1-120 PSI into the nozzle 80 of the mixing chamber 70, where the internals of the nozzle 80 break the particle sizes down and ejected particles atomize with the low CFM air produced by the DC blower motor 30.

Flow of the pressurized fogging liquid 50 from the container 52 may be controlled with the activation switch 60, a shut of valve for safety, and/or a liquid trigger through the tube 56. The pressurized fogging liquid 50 may travel within the tube 56 and into the nozzle 80, which is center mounted in the mixing chamber 70. The pressurized fogging liquid 50 dispensed through the nozzle 80 may be broken down by the nozzle 80 as a fan, cone, flat, spray jet, or other shape. With a 10°-85° degree opening and an orifice size smaller than 0.05 inches. As the broken-down liquid particles eject from nozzle 80, they will atomize with the air flow 12 and then exit the opening 74 of the mixing chamber 70. It is noted that if the opening 74 of the mixing chamber 70 is smaller than the mixing chamber 70, the air and fogging liquid 50 will be compressed through the opening 74 and forced to atomize.

In use, the DC-powered blower motor 30, which is powered by a DC battery 40, may be activated via switch 60 to activate the DC blower motor 30. Then, the container 52 may be pumped with the manual pump via the top pump. The pressurized fogging liquid 50 is released from the container 52 and travels through the tubes 56, past a flow control valve (second switch 64), and into the mixing chamber 70. The dispensed portion of the fogging liquid 50 is ejected from the nozzle 80 as small, broken-down particles, which atomize with the forced air prior to exiting the opening 74 of the mixing chamber 70 to create small particle, ultra-low volume fog or mist.

When an automatic liquid pressure system is used, it may be powered by the DC blower motor 30 and/or the battery 40. In this design the DC blower motor 30 may electrically operate an automatic liquid pumping device located in or near the container 52. A tube 56 transports the pressurized source to control the liquid to the nozzle 80, controlled by a shut of valve for safety or a liquid trigger. The pressurized fogging liquid may travel the tube 56 exit the nozzle 80 as described relative to the manual pressurization example. The liquid may also be unpressurized and flow to the mixing chamber via a tube 56, and the liquid is siphoned in to the nozzle 80 in part because of gravity and or a siphoning effect caused by the venturi in the mixing chamber 70. The venturi is the movement of the fluid due to the Venturi effect, which is the reduction in fluid pressure that results when a fluid flows through a constricted section (or choke) of a pipe.

As will be discussed herein, the apparatus 10 may provide significant benefits with fogging or misting insects or other biological material in tight spaces, such as attics, or in remote locations where corded-power is not readily available. Furthermore, the apparatus 10 provides significant benefits over thermal foggers, which have many drawbacks. For one, the apparatus 10 does not require heat or a propane or gas fuel. Secondly, the apparatus 10 will have less of a tendency to contaminate non-intended areas with fog, since it can produce particulate at the optimal size adjustable between ULV micron(s) 20 microns to mist size microns of up to 150 micron(s), whereas thermal foggers produce particulate at smaller sizes which tend to easily spread to non-intended application areas.

Conventional AC corded-power foggers typically produce typically less than 120 CFM and wind speeds of less than 170 MPH. However, this CFM and wind speeds is unable to atomize liquid with the conventional AC corded-power foggers using a vortex and turbine design which requires siphoning of the liquid to disperse the fog. Specifically, low powered CFM blow motors producing less than 170 MPH wind speeds and less than 120 CFMs cannot create the siphoning effect from the low pressure of air passing through the vortex/turbine. If pressurized stream is introduced to the jet while the blow motor is forcing its low air pressure through the channel, the liquid will exit the chamber without being atomized, misted or fogged. The stream, even when introduced at low liquid pressure, will bypass the forced air and simply not atomize unless the design incorporates a tank slightly higher than the nozzle as in our drawing and a mixing nozzle which encompasses a nozzle of the sizes we specified and has the nozzle the correct distance from the mixing chamber orifice to create enough of a venturi to siphon a enough of the solution from the gravity fed tank above the nozzle to allow the liquid to eject and atomize.

Similar to the conventional AC corded-powered blow motors, the DC blower motor 30 described herein also yields low CFM distribution and optimal wind speeds, typically less than 120 CFM and wind speeds of less than 170 MPH. However, the DC blower motor 30 only uses power provided by a battery 40. If a conventional AC blow motor used a battery that was portable, there may be enough energy to last a few minutes at most. In contrast, use of the DC blower motor 30 with the battery 40 can provide energy for a significant time period, commonly 45 minutes or more of operating time. There is a significant need in the industry for a fogger that can produce optimal fogging particulate sizes, operate for more than a trivial time period (under 10 minutes), and be handheld and portable. It should be understood the apparatus will provide even greater performance for units with higher powered CFM and wind speeds over 200 MPH.

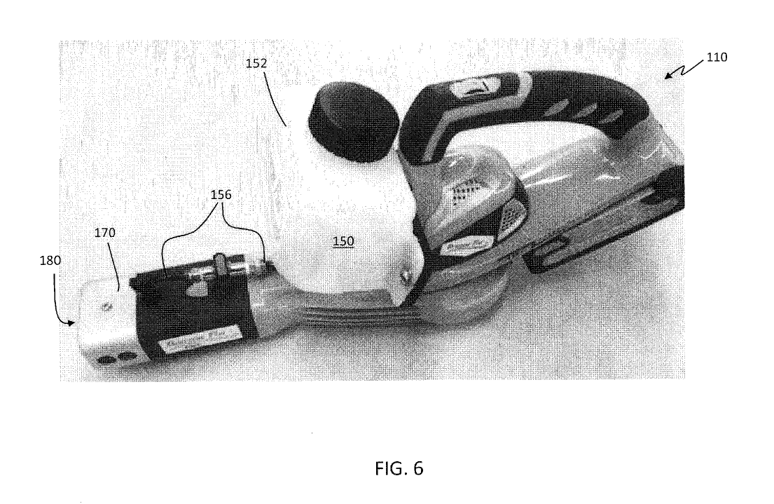

FIG. 6 is a side view illustration of a fogger apparatus 110, in accordance with a second exemplary embodiment of the present disclosure. The fogger apparatus 110 may include many of the same features as described relative to the first embodiment and FIGS. 1-5, all of which are incorporated by reference in the second embodiment. In contrast to the first embodiment, instead of using pressurized fogging liquid, the fogger apparatus 110 may utilize a gravity-fed design to release the quantity of fogging liquid 150 from the container 152 in which it is housed. As shown in FIG. 6, the fogger apparatus 110 with a gravity-fed design may include allowing the fogging liquid 150 to flow from the container 152 and through a tube 156 to the nozzle 180 which is center mounted in the mixing chamber 170 without the need to pressurize the container 152. The fogging liquid 150 dispensed through the nozzle 180 may be broken down by the nozzle 180 as described relative to FIGS. 1-5.

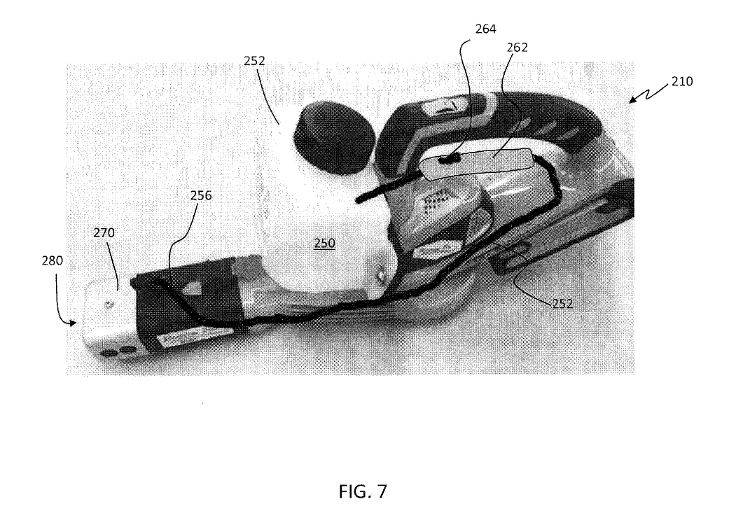

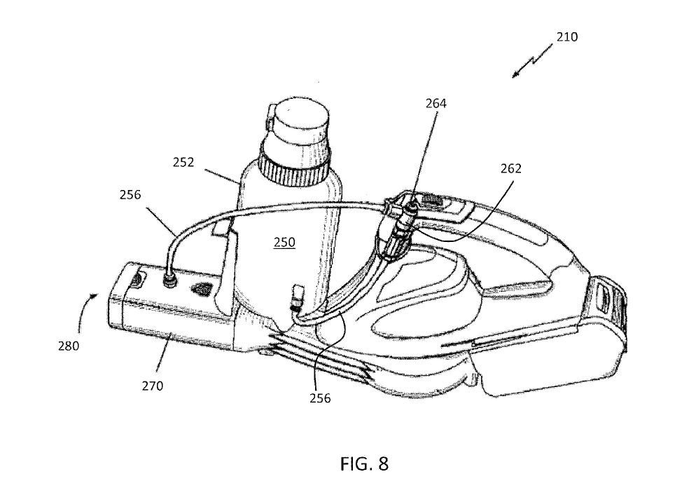

FIGS. 7-8 are side view illustrations of a fogger apparatus 210, in accordance with a third exemplary embodiment of the present disclosure. The fogger apparatus 210 may include many of the same features as described relative to the first and second embodiments and FIGS. 1-6, all of which are incorporated by reference in the second embodiment. In contrast to the first embodiment and second embodiment, instead of using pressurized fogging liquid, the fogger apparatus 210 may utilize a gravity-fed design to release the quantity of fogging liquid 250 from the container 252 in which it is housed, which operates in conjunction with an inline battery operated liquid pump 262 with a switch 264 which controls the liquid pump 262. As shown in FIG. 7, the fogger apparatus 210 with a gravity-fed design allows the fogging liquid 250 to flow from the container 252 through tube 256 and to an inline pump 262. The inline pump 262, which may be a ball valve or a similar type of fluid pump, may draw the fogging liquid 250 from the container 252 when the tub 256 enters the container 252 at an elevated position on the container, as shown in FIG. 7, or when the tube 256 enters the container 252 at a bottom portion of the container 252, as shown in FIG. 8. The inline pump 262 may transfer the fogging liquid 250 through the tube 256 and to the nozzle 280 which is center mounted in the mixing chamber 270 without the need to pressurize the container 252. The fogging liquid 250 dispensed through the nozzle 280 may be broken down by the nozzle 280 as described relative to FIGS. 1-5.

The use of the inline pump 262 may allow for the apparatus 210 to operate in all orientations, including orientations where the container 252 is not positioned vertically upright, as shown in FIGS. 7-8. For example, if a user orients the apparatus 210 in a sideways or upside down position, the inline pump 262 may maintain the movement of the fogging liquid 250 through the tubes 256, absent gravity or tank pressurization. As shown in both FIGS. 7-8, the switch 264 may be positioned proximate to the handle of the apparatus 210, thereby allowing a user easy access to actuating the switch 264 as desired to control the flow of the fogging liquid 250. The inline pump 262 and the switch 264 for the inline pump 262 may be positioned together or near one another, or may be positioned remote from one another. For example, the inline pump 262 may be positioned near the container 252 while the switch 264 may be positioned on the handle of the apparatus 210.

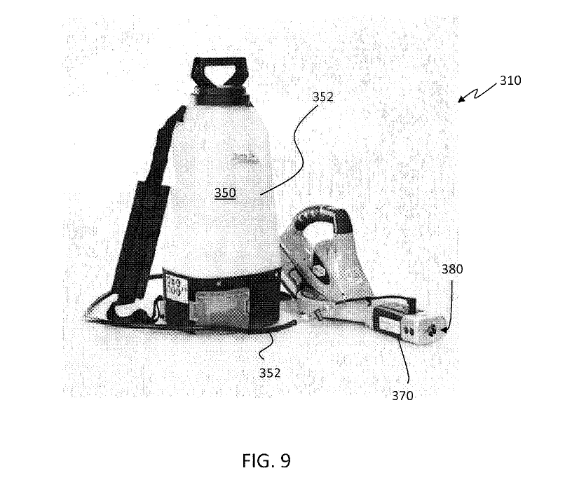

FIG. 9 is a side view illustration of a fogger apparatus 310, in accordance with a fourth exemplary embodiment of the present disclosure. The fogger apparatus 310 may include many of the same features as described relative to any other embodiments of this disclosure, all of which are incorporated by reference in the third embodiment. In contrast to FIG. 1, the container 352 housing the quantity of fogging liquid 350 may be carried separately from the body of the apparatus 310. For example, the container 352 may be carried on the back of the user with one or more backpack straps positioned over the shoulder of the user. The container 352 may be connected to the mixing chamber 370 and the nozzle 380 with one or more tubes 356. It is noted that the container 352 may be pressurized and/or gravity fed and/or operate with an inline pump, as previously described.

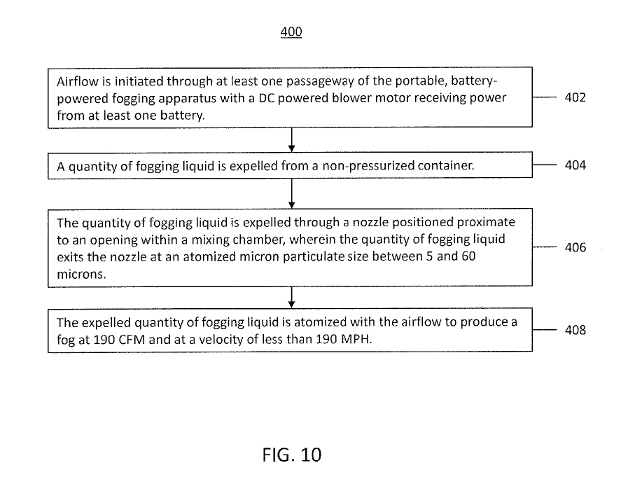

FIG. 10 is a flowchart 400 illustrating a method of generating a low-CFM fog with a portable, battery-powered fogging apparatus in accordance with a fifth exemplary embodiment of the disclosure. It should be noted that any process descriptions or blocks in flow charts should be understood as representing modules, segments, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 402, airflow is initiated through at least one passageway of the portable, battery-powered fogging apparatus with a DC powered blower motor receiving power from at least one battery. A quantity of fogging liquid is expelled from a non-pressurized container (block 404). The quantity of fogging liquid is expelled through a nozzle positioned proximate to an opening within a mixing chamber, wherein the quantity of fogging liquid exits the nozzle at an atomized micron particulate size between 5 and 60 microns (block 406). The expelled quantity of fogging liquid is atomized with the airflow to produce a fog at 190 CFM and at a velocity of less than 190 MPH (block 408).

The method may include any additional number of steps or variations thereof, including any of the processes, functions, or structures disclosed within this disclosure. For example, activation of the DC blower motor and/or expelling of the portion of the quantity of fogging liquid may be controlled with at least one activation switch. The nozzle may be positioned a predetermined distance from an opening of the mixing chamber, such as less than one inch from the opening. When the quantity of fogging liquid is atomized with the airflow, it is done without the use of a heat source and solely with the at least one battery.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A fogger apparatus comprising:
a portable fogger body;
a DC blower motor positioned on the portable fogger body and powered with at least one battery, wherein the DC blower motor produces an air flow through at least one passageway within the portable fogger body;
a quantity of fogging liquid housed within a container fluidly connected to the portable fogger body, wherein at least a portion of the quantity of fogging liquid is dispensable from the container;
an activation switch controlling at least one of activation of the DC blower motor and dispensing of the portion of the quantity of fogging liquid; and
a mixing chamber receiving the air flow and the dispensed portion of the quantity of fogging liquid, wherein the dispensed portion of the quantity of fogging liquid is expelled through a nozzle as a particulate having a size less than 25 microns.

2. The fog generating apparatus of claim 1, wherein the container is a non-pressurized container.

3. The fog generating apparatus of claim 1, wherein the quantity of fogging liquid is released from the container using only gravity.

4. The fog generating apparatus of claim 1, wherein the container is carried separately from the portable fogger body and is fluidly connected to the portable fogger body, wherein the container is configured to be carried on a back of a user.

5. The fog generating apparatus of claim 1, further comprising at least one fluid transporting structure connected between the container and the mixing chamber, wherein the at least one fluid transporting structure further comprises a first fluid transporting tube connected between the container and the activation switch and a second fluid transporting tube connected between the activation switch and the mixing chamber.

6. The fog generating apparatus of claim 1, wherein the atomized micron particulate size between 5 and 60 microns further comprises at least 90% under 20-25 microns.

7. The fog generating apparatus of claim 1, further comprising an opening within the mixing chamber, wherein the nozzle is positioned a predetermined distance from the opening.

8. The fog generating apparatus of claim 7, wherein the opening of the mixing chamber is sized smaller than a cross-sectional size of the mixing chamber.

9. The fog generating apparatus of claim 7, wherein the nozzle is positioned less than one inch from the opening.

10. The fog generating apparatus of claim 1, wherein the nozzle further comprises a fluid path terminating at an orifice, wherein the orifice further comprises at least two angled sides.

11. The fog generating apparatus of claim 1, wherein the quantity of fogging liquid housed within the container is dispelled from the container using gravity, wherein at least a portion of the quantity of fogging liquid is released through a fluid tube positioned proximate to a bottom of the container.

12. The fog generating apparatus of claim 1, further comprising an outer housing positioned around the nozzle and a fastening member connected between at least one of the outer housing and the nozzle and a wall of the mixing chamber, wherein the fastening member holds the nozzle in a substantially stationary, predetermined position relative to an opening formed within the mixing chamber.

13. The fog generating apparatus of claim 1, wherein the container is non-pressurized, and further comprising a battery-powered inline fluid pump positioned in fluid communication with the non-pressurized container, wherein the inline fluid pump draws a portion of the quantity of fogging liquid from the non-pressurized container.

14. The fog generating apparatus of claim 13, further comprising an activation switch controlling an activation of the battery-powered inline fluid pump.

15. A method of generating a low-CFM fog with a portable, battery-powered fogging apparatus, the method comprising the steps of:
initiating an airflow through at least one passageway of the portable, battery-powered fogging apparatus with a DC powered blower motor receiving power from at least one battery;
expelling a quantity of fogging liquid from a non-pressurized container;
expelling the quantity of fogging liquid through a nozzle positioned proximate to an opening within a mixing chamber, wherein the quantity of fogging liquid exits the nozzle at an atomized micron particulate size between 5 and 60 microns; and
atomizing the expelled quantity of fogging liquid with the airflow to produce a fog at 190 CFM and at a velocity of less than 190 MPH.

16. The method of claim 15, further comprising the step of controlling at least one of activation of the DC blower motor and expelling of the portion of the quantity of fogging liquid with at least one activation switch.

17. The method of claim 15, further comprising the step of positioning the nozzle a predetermined distance from an opening of the mixing chamber.

18. The method of claim 15, wherein the expelled quantity of fogging liquid is atomized with the airflow without the use of a heat source and solely with the at least one battery.

19. The method of claim 15, wherein the quantity of fogging liquid is expelled from the non-pressurized container using gravity and at least one of:
a venturi created within the mixing chamber; and
a battery-powered inline fluid pump positioned in fluid communication between the container and the mixing chamber.

20. A fogger apparatus comprising:
a portable fogger body;
a DC blower motor positioned on the portable fogger body and powered with at least one battery, wherein the DC blower motor produces an air flow through at least one passageway within the portable fogger body;
a quantity of fogging liquid housed within a container fluidly connected to the portable fogger body, wherein at least a portion of the quantity of fogging liquid is dispensable from the container using gravity;
a first activation switch controlling activation of the DC blower motor;
a second activation switch controlling a pump positioned inline with fluid tubes connected to the container, wherein the second activation switch controls dispensing of a portion of the quantity of fogging liquid from the container; and
a mixing chamber receiving the air flow and the dispensed portion of the quantity of fogging liquid, wherein the dispensed portion of the quantity of fogging liquid is expelled through a nozzle as a particulate having a size less than 25 microns.
